(19) United States
(12) Patent Application Publication
(10) Pub. No.: US 2019/0143836 A1
(43) Pub. Date: May 16, 2019

(54) THERMAL EXCHANGE PLATE OF A VEHICLE BATTERY PACK AND THERMAL EXCHANGE PLATE ASSEMBLY METHOD

(71) Applicant: Ford Global Technologies, LLC, Dearborn, MI (US)

(72) Inventors: Neil Robert Burrows, White Lake Township, MI (US); Amir Amirfazli, Northville, MI (US); John Bilezikjian, Canton, MI (US)

(21) Appl. No.: 15/810,235

(22) Filed: Nov. 13, 2017

(51) Int. Cl. B60L 11/18; H01M 10/625; H01M 10/6554; H01M 10/6556

(52) U.S. Cl. CPC B60L 11/1874; H01M 10/6556; H01M 10/6554; H01M 10/625

(57) ABSTRACT

An exemplary battery assembly includes, among other things, a first thermal exchange plate having a male feature, and a second thermal exchange plate having a female feature. The male and female features are interlockable with one another to limit separation between the first and second thermal exchange plates. An exemplary method includes, among other things, interlocking a male feature of a first thermal exchange plate with a female feature of a second thermal exchange plate to limit separation between the first and second thermal exchange plates.

### TECHNICAL FIELD

This disclosure relates generally to a thermal exchange plate of a vehicle battery pack and, more particularly, to a thermal exchange plate having a modular-type construction.

### BACKGROUND

Generally, electrified vehicles differ from conventional motor vehicles because electrified vehicles are selectively driven using one or more battery-powered electric machines. Conventional motor vehicles, in contrast to electrified vehicles, are driven exclusively with an internal combustion engine. Electrified vehicles may use electric machines instead of, or in addition to, the internal combustion engine.

Example electrified vehicles include hybrid electric vehicles (HEVs), plug-in hybrid electric vehicles (PHEVs), fuel cell vehicles, and battery electric vehicles (BEVs). A powertrain for an electrified vehicle can include a high-voltage battery pack having battery cells that store electric power for powering the electric machines and other electrical loads of the electrified vehicle.

Traction batteries of electrified vehicles typically include a plurality of arrays each having individual battery cells that are periodically recharged to replenish the energy necessary to power the electric machines. Battery cells can heat up during charging and discharging, and during other stages of operation. Operating the battery cells at certain temperatures can improve the capacity and the life of the battery cells.

### SUMMARY

A battery assembly according to an exemplary aspect of the present disclosure includes, among other things, a first thermal exchange plate having a male feature, and a second thermal exchange plate having a female feature. The male and female features are interlockable with one another to limit separation between the first and second thermal exchange plates.

In a further non-limiting embodiment of the foregoing assembly, the male feature is slideably received within the female feature.

A further non-limiting embodiment of any of the foregoing assemblies includes at least one pin that interfaces with the male feature and the female feature to limit the male feature and the female feature from sliding relative to each other.

In a further non-limiting embodiment of any of the foregoing assemblies, the male and female features have a dovetail-type cross-sectional profile.

In a further non-limiting embodiment of any of the foregoing assemblies, a geometry of the first thermal exchange plate mimics a geometry of the second thermal exchange plate.

In a further non-limiting embodiment of any of the foregoing assemblies, the first and second thermal exchange plates are extruded structures.

In a further non-limiting embodiment of any of the foregoing assemblies, the male feature and the remaining portions of the first thermal exchange plate are formed together as a single unitary structure.

In a further non-limiting embodiment of any of the foregoing assemblies, the first and second thermal exchange plates each include a plurality of coolant channels having first ends opening to respective first sides of the first and second thermal exchange plates and second ends opening to respective second sides of the first and second thermal exchange plates. The first sides are opposite the second sides.

A further non-limiting embodiment of any of the foregoing assemblies includes a first manifold adjacent the first sides and a second manifold adjacent the second sides. The first and second manifolds are configured to communicate a coolant from some of the plurality of coolant channels to others of the plurality of coolant channels.

In a further non-limiting embodiment of any of the foregoing assemblies, the male feature of the first thermal exchange plate extends along a longitudinal axis, and the plurality of coolant channels of the first thermal exchange plate extend from the first side to the second side along respective coolant channel axes that are substantially parallel to the longitudinal axis of the male feature.

A further non-limiting embodiment of any of the foregoing assemblies includes a battery pack wall with a battery pack wall interlock feature that is interlockable with a corresponding battery pack wall interlock feature of the first thermal exchange plate.

In a further non-limiting embodiment of any of the foregoing assemblies, the battery pack wall interlock feature of the battery pack wall is slideably engaged with the battery pack wall interlock feature of the first thermal exchange plate.

In a further non-limiting embodiment of any of the foregoing assemblies, the battery pack wall interlock features of the battery pack wall and the first thermal exchange plate extend along respective longitudinal axes, and the battery pack wall is pivotable relative to the first thermal exchange plate about the longitudinal axes.

A further non-limiting embodiment of any of the foregoing assemblies includes a plurality of battery cells and a tensioning member. The tensioning member is configured to hold the battery pack wall in a pivoted position where the battery pack wall compresses the plurality of battery cells.

A further non-limiting embodiment of any of the foregoing assemblies includes a female feature of the first thermal exchange plate on a side of the thermal exchange plate opposite the male feature. The female feature of the first thermal exchange plate has a cross-sectional profile mimicking a cross-sectional profile of the male feature of the first thermal exchange plate.

A method according to another exemplary aspect of the present disclosure includes, among other things, interlocking a male feature of a first thermal exchange plate with a female feature of a second thermal exchange plate to limit separation between the first and second thermal exchange plates.

A further non-limiting embodiment of the foregoing method includes slideably receiving the male feature within the female feature to interlock the first and second thermal exchange plates.

A further non-limiting embodiment of the foregoing method includes, after the interlocking, pinning the male and female features to prevent withdrawal of the male feature from the female feature.

In a further non-limiting embodiment of the foregoing method, the male feature extends along a first side of the first thermal exchange plate and the method includes interlocking a third thermal exchange plate or a battery pack wall with a female feature of the first thermal exchange plate. The female feature of the first thermal exchange plate extends along a second side of the first thermal exchange plate that is opposite the second side.

In a further non-limiting embodiment of the foregoing method, the male feature that extends along the first side of the first thermal exchange plate has a cross-sectional profile that mimics a cross-sectional profile of the female feature that extends along the second side of the first thermal exchange plate.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DESCRIPTION OF THE FIGURES

The various features and advantages of the disclosed examples will become apparent to those skilled in the art from the detailed description. The figures that accompany the detailed description can be briefly described as follows:

FIG. 1 illustrates a schematic view of a powertrain of an electrified vehicle.

FIG. 2 illustrates a schematic view of selected portions of a battery pack from the powertrain of FIG. 1 having a plurality of thermal exchange plates interlocked together.

FIG. 3 illustrates an end view of a plurality of thermal exchange plates of FIG. 2.

FIG. 4 illustrates a perspective view of one of the thermal exchange plates slideably engaging with another of the thermal exchange plates from FIG. 3.

FIG. 5 illustrates a perspective view of the thermal exchange plates from FIG. 3 with connections to a cooling system shown schematically.

FIG. 6 illustrates an end view of the plurality of thermal exchange plates from FIG. 3 interlocked to battery pack walls of the battery pack.

FIG. 7 illustrates a plurality of thermal exchange plates interlocking with battery pack walls according to another exemplary embodiment of the present disclosure.

FIG. 8 illustrates one of the battery pack walls slideably engaging with one of the plurality of battery pack walls from FIG. 7.

FIG. 9 illustrates the battery pack walls from FIG. 7 in an installed position.

FIG. 10 illustrates a plurality of thermal exchange plates and a battery pack wall according to yet another exemplary embodiment of the present disclosure.

FIG. 11 illustrates a battery pack wall moving toward an interlocked position with one of the plurality of thermal exchange plates from FIG. 10.

FIG. 12 illustrates the plurality of endplates and battery pack walls from FIG. 11 interlocked with one another.

FIG. 13 illustrates a plurality of endplates according to yet another exemplary embodiment of the present disclosure moving toward an interlocked position with each other.

FIG. 14 illustrates the thermal exchange plates of FIG. 13 interlocked with each other.

FIG. 15 illustrates an endplate and battery pack wall according to yet another exemplary embodiment of the present disclosure.

FIG. 16 illustrates the thermal exchange plate and battery pack wall of FIG. 15 interlocked with one another.

FIG. 17 illustrates a thermal exchange plate interlocked with a battery pack wall according to yet another exemplary embodiment of the present disclosure.

### DETAILED DESCRIPTION

This disclosure details thermal exchange plates for use within battery packs of electrified vehicles.

An exemplary battery assembly includes thermal exchange plates that interlock with each other, and potentially other structures, via male and female type attachment structures. The interlocking limits separation of the thermal exchange plates. The thermal exchange plates are modular in nature. Accordingly, additional thermal exchange plates can be added and interlocked within the assembly to increase an overall size of the battery pack.

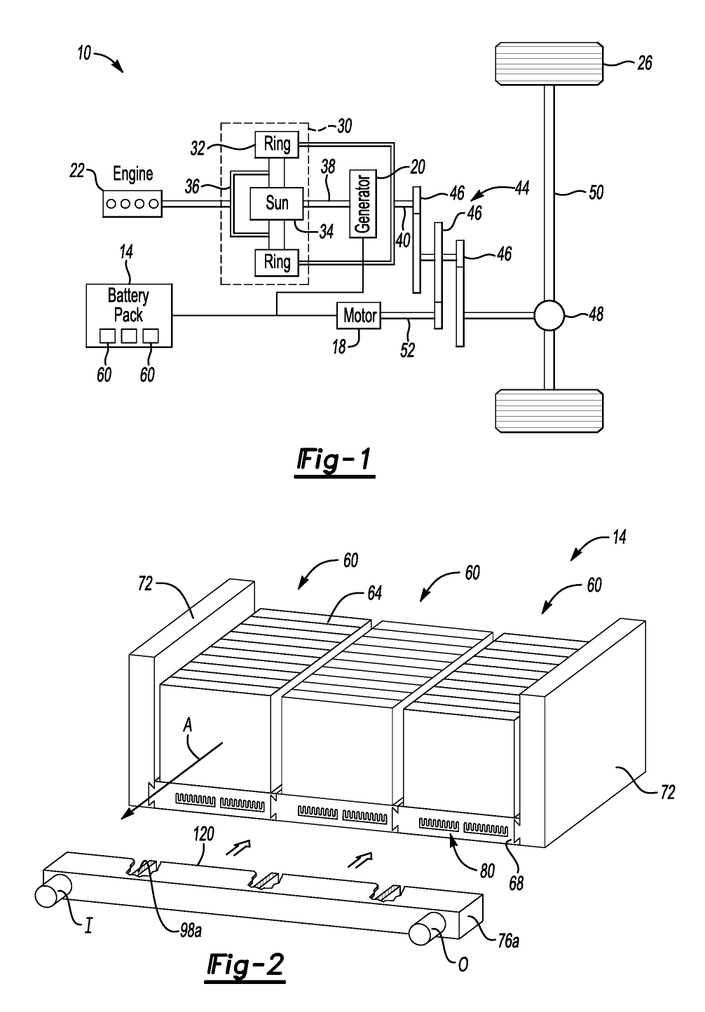

FIG. 1 schematically illustrates a powertrain 10 for an electrified vehicle, which is a hybrid electric vehicle (HEV) in this example. Although depicted as an HEV, it should be understood that the concepts described herein are not limited to HEVs and could extend to other types of electrified vehicle, including, but not limited to, plug-in hybrid electric vehicles (PHEVs), battery electric vehicles (BEVs), fuel cell vehicles, etc.

The powertrain 10 includes a battery pack 14, a motor 18, a generator 20, and an internal combustion engine 22. The motor 18 and generator 20 are types of electric machines. The motor 18 and generator 20 may be separate or may have the form of a combined motor-generator.

In this embodiment, the powertrain 10 is a power-split powertrain system that employs a first drive system and a second drive system. The first and second drive systems generate torque to drive one or more sets of vehicle drive wheels 26 of the electrified vehicle. The first drive system includes a combination of the engine 22 and the generator 20. The second drive system includes at least the motor 18, the generator 20, and the battery pack 14. The motor 18 and the generator 20 are portions of an electric drive system of the powertrain 10.

The engine 22, which is an internal combustion engine in this example, and the generator 20 may be connected through a power transfer unit 30, such as a planetary gear set. Of course, other types of power transfer units, including other gear sets and transmissions, could be used to connect the engine 22 to the generator 20. In one non-limiting embodiment, the power transfer unit 30 is a planetary gear set that includes a ring gear 32, a sun gear 34, and a carrier assembly 36.

The generator 20 can be driven by engine 22 through the power transfer unit 30 to convert kinetic energy to electrical energy. The generator 20 can alternatively function as a motor to convert electrical energy into kinetic energy, thereby outputting torque to a shaft 38 connected to the power transfer unit 30. Because the generator 20 is operatively connected to the engine 22, the speed of the engine 22 can be controlled by the generator 20.

The ring gear 32 of the power transfer unit 30 can be connected to a shaft 40, which is connected to vehicle drive wheels 26 through a second power transfer unit 44. The second power transfer unit 44 may include a gear set having a plurality of gears 46. Other power transfer units may also be suitable.

The gears 46 transfer torque from the engine 22 to a differential 48 to ultimately provide traction to the vehicle drive wheels 26. The differential 48 may include a plurality of gears that enable the transfer of torque to the vehicle drive wheels 26. In this example, the second power transfer unit 44 is mechanically coupled to an axle 50 through the differential 48 to distribute torque to the vehicle drive wheels 26.

The motor 18 can also be employed to drive the vehicle drive wheels 26 by outputting torque to a shaft 52 that is also connected to the second power transfer unit 44. In one embodiment, the motor 18 and the generator 20 cooperate as part of a regenerative braking system in which both the motor 18 and the generator 20 can be employed as motors to output torque. For example, the motor 18 and the generator 20 can each output electrical power to the battery pack 14.

Referring now to FIG. 2 with continuing reference to FIG. 1, the battery pack 14 provides a relatively high-voltage battery that can store generated electrical power and can output electrical power to operate the motor 18, the generator 20, or both. The battery pack 14 includes at least one array 60 of individual battery cells 64 arranged side by side along a longitudinal axis A. In this example, the battery pack 14 includes three arrays 60. The battery pack 14 further includes a plurality of thermal exchange plates 68, battery pack walls 72, and a manifold 76a.

The thermal exchange plates 68 include internal coolant channels 80. During operation, coolant can move through the coolant channels 80 to control thermal energy levels within the individual battery cells 64 and other portions of the battery pack 14.

The battery cells 64 can have an axial width that is from 120 to 200 millimeters. In some examples, the battery cells 64 are lithium-ion pouch cells having an axial width that is greater than 200 millimeters. Each array 60 could include, for example, sixty to seventy-six individual battery cells 64.

The battery pack 14 could include other structures, such as additional battery pack walls spanning across the arrays 60 at each axial end from one of the battery pack walls 72 to the opposing battery pack wall 72. Another structure could include an enclosure that houses the components depicted in FIG. 2, such as a polymer-based enclosure having a lid secured to a tray to provide an open area that receives the components shown in FIG. 2.

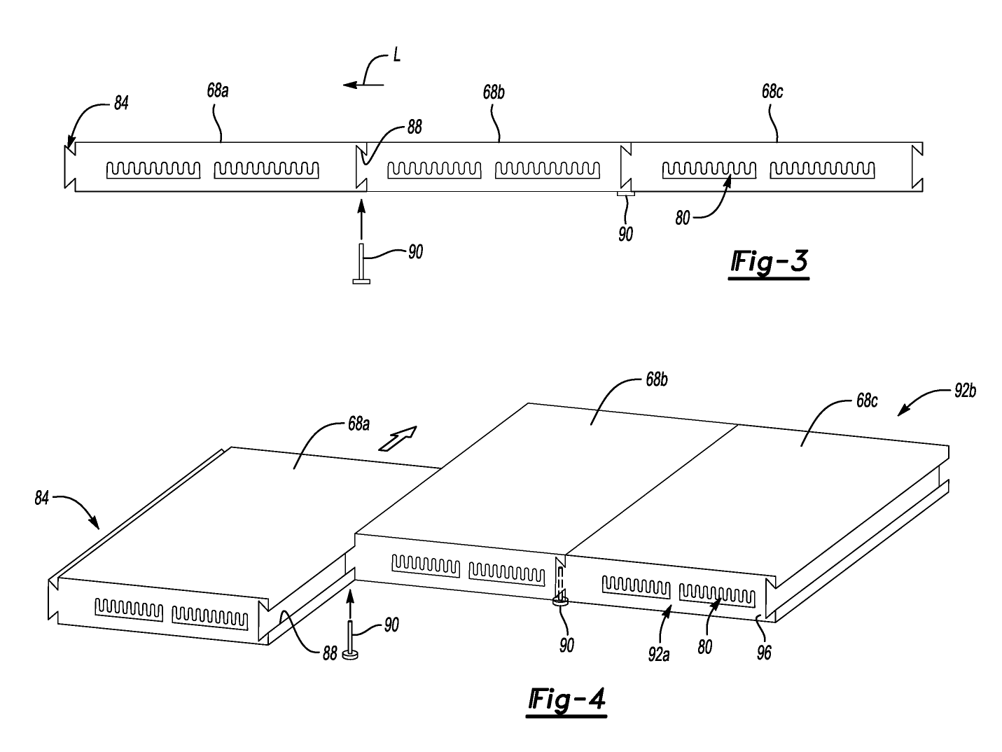

Referring now to FIGS. 3 and 4 with continuing reference to FIG. 2, the thermal exchange plate 68a is shown transitioning to an installed position relative to the thermal exchange plate 68b. The thermal exchange plates 68b and 68c are shown in an installed position.

The thermal exchange plates 68a-68c, in this exemplary non-limiting embodiment, each include interlock features. In this example, the interlock features include a male feature 84 along a lateral side, and a female feature 88 along an opposing lateral side. In this exemplary non-limiting embodiment, the male feature 84 has a dovetail-type cross-sectional profile. A cross-sectional profile of the female feature 88 also has a dovetail-type profile. The cross-sectional profiles of the male feature 84 and the female feature 88 mimic each other.

Within the battery pack 14, the thermal exchange plate 68a interlocks with the thermal exchange plate 68b by sliding the thermal exchange plates relative 68a, 68b relative to each other such that the male feature 84 of the thermal exchange plates 68b is received within the female feature 88 of the thermal exchange plate 68a.

When the male feature 84 is received within the female feature 88, the thermal exchange plates 68a, 68b are manually interlocked together in an interlocked position. The interlocking limits the thermal exchange plates 68a, 68b from separating laterally relative to each other. That is, with reference to FIG. 3, the interlocking prevents the thermal exchange plate 68a from separating away from the thermal exchange plate 68b in the direction L, which is transverse to the axis A.

The female feature 88 of the thermal exchange plate 68b also interlocks with the male feature 84 of the thermal exchange plate 68c to prevent the thermal exchange plates 68b, 68c from separating laterally relative to each other.

When the thermal exchange plates 68a-68c are in the installed position relative to each other, pins 90 can be positioned to extends through the female features 88 and the male feature 84 received within that female feature 88. The pins 90 hold the thermal exchange plates 68a-68c in the installed position by preventing the male features 84 from sliding axially relative to the female features 88. The pins 90 could be screws in some examples that are counter sunk within the thermal exchange plates 68a-68c. In some examples, adhesives (or sealants) are used instead of, or in addition to the pins 90 to hold the male features 84 within the respective female features 88. The adhesives, if used, can be applied to one or more surfaces of the male feature 84 and female features 88. In some examples, the pins 90 are used to hold the positions of the thermal exchange plates 68a-68c as an adhesive cures, and then removed after the adhesive has cured.

Notably, the geometries of thermal exchange plates 68a-68c mimic each other. That is, a geometry of the thermal exchange plate 68a is substantially the same as a geometry of the thermal exchange plates 68b, 68c. Because the geometries mimic each other, the thermal exchange plate 68a could be used in place of the thermal exchange plate 68b or 68c, the thermal exchange plate 68c in place of the thermal exchange plate 68a or 68b, etc. Further, because the geometries mimic each other, a single extrusion tool can be used to manufacture all the thermal exchange plates 68a-68c.

As required, additional thermal exchange plates could be added to the battery pack 14 to increase, laterally, a size of the battery pack 14 and permit the battery pack 14 to accommodate more of the arrays 60. The modular design of the thermal exchange plates 68a-68c can thus provide design flexibility.

The thermal exchange plates 68a-68c can be extruded structures that extruded together in a direction aligned with the axis A, and then cut to a desired axial length. Extruding the thermal exchange plates 68a-68c can, among other things, reduce manufacturing time when compared to processes that could require welding, casting, etc. The male features 84 are female features 88 can be extruded together as a single unitary structure with the remaining portions of respective the thermal exchange plates 68a-68c. The skilled person would understand the structural distinctions between an extruded component and, for example, a cast component. In other examples, the thermal exchange plates 68a-68c are instead cast, or manufactured by another process other than an extrusion process.

The coolant channels 80 can be provided as the thermal exchange plates 68a-68c are extruded. Extruding the coolant channels 80 within the thermal exchange plates 68a-68c can reduce manufacturing complexity and potential leak paths associated with more complex assemblies.

The coolant channels 80 each extend axially between first ends opening to respective first sides 92a of the thermal exchange plates 68a-68c and second ends opening to respective second sides 92b of the thermal exchange plates 68a-68c opposite the first sides 92a.

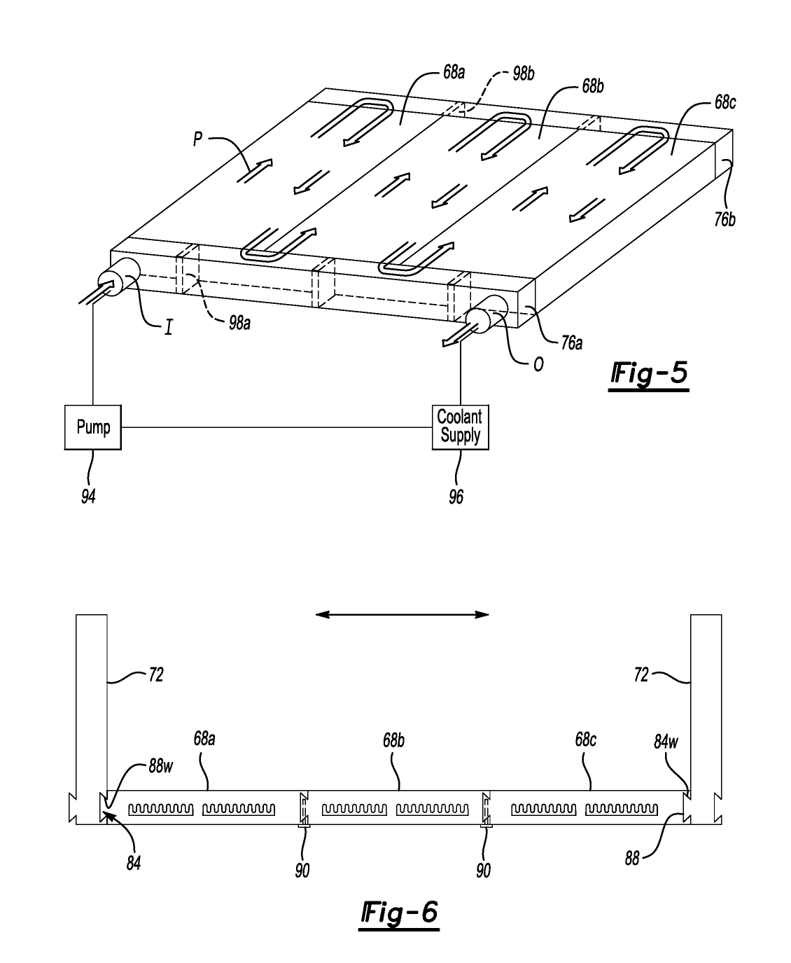

Referring now to FIG. 5, with continuing reference to FIGS. 2-4, the manifold 76a can be placed against the respective first sides 92a of the thermal exchange plates 68a-68b to cover the first ends of the coolant channels 80. Another manifold 76b can be placed against the respective second sides 92b of the thermal exchange plates 68a-68b to cover the second ends of the coolant channels 80. The manifolds 76a and 76b can be secured with adhesives, mechanical fasteners, etc.

During operation, a coolant, such as a liquid coolant, can be moved by a pump 94 from a coolant supply 96 to an inlet I of the manifold 76a. The coolant moves through the inlet I and then is directed along a path P, in part by a baffle 98a of the manifold 76a, to move axially through the coolant channels 80 on a first lateral side of the thermal exchange plate 68a. A baffle 98b within the manifold 76b then turns and redirects the coolant back through the coolant channels 80 on an opposite, second lateral side of the thermal exchange plate 68a.

The flow of coolant then continues through the thermal exchange plates 68b and 68c directed and turned by other baffles within the manifold 76a and the manifold 76b. After passing through the thermal exchange plate 68c into the manifold 76a, the coolant communicates through an outlet O of the manifold 76a and returns to the coolant supply 96.

The coolant, which may be heated from circulating through the thermal exchange plates 68a-68c, can be passed through a heat exchanger (not shown) to remove thermal energy from the coolant prior to returning the coolant to the coolant supply 96. The circulation of coolant through the thermal exchange plate 68a-68c can carry thermal energy from the individual battery cells 64 and remaining portions of the battery pack 14, thereby cooling the battery pack 14. In other examples, the coolant may be used to heat the battery cells 64 and other areas of the battery pack 14.

The exemplary thermal exchange plates 68a-68c can thus convey coolant via the coolant channels 80 without requiring internal coolant ports, which can reduce potential leak paths for coolant moved through the coolant channels 80.

Referring now to FIG. 6 with continuing reference to FIGS. 2-5, the thermal exchange plate 68a can interlock with one of the battery pack walls 72 via interlock features. In this example, the interlock features of one of the battery pack walls 72 interlock with the male feature 84 of the thermal exchange plate 68a. Similarly, the thermal exchange plate 68c can interlock with another battery pack wall 72 via the female feature 88 of the thermal exchange plate 68c.

To interlock the male feature 84 of the thermal exchange plate 68a with the battery pack wall 72, the male feature 84 is slideably received within a female feature 88_{w} of the battery pack wall 72. To interlock the thermal exchange plate 68c with another of the battery pack walls 72, the female feature 88 of the thermal exchange plate 68c receives a male feature 84_{w} of the battery pack wall 72.

If the battery pack 14 were required to accommodate more than three arrays 60, an additional thermal exchange plate could interlock with the female feature 88 of the thermal exchange plate 68c rather than the battery pack wall 72. The battery pack wall 72 formerly engaging the thermal exchange plate 68c could then be slideably received within a groove of the added thermal exchange plate. Like the thermal exchange plates 68a-68c, the battery pack walls 72 can be extruded.

Like interlocking of the thermal exchange plates 68a-68c, the battery pack walls 72 can be held relative to the respective thermal exchange plate 68a or 68c with adhesives, pins, or both. The pins could be removed after an adhesive has cured, for example.

In this disclosure, like reference numerals designate like elements where appropriate, and reference numerals with the addition of one-hundred or multiples thereof designate modified elements. The modified elements incorporate the same features and benefits of the corresponding modified elements, expect where stated otherwise.

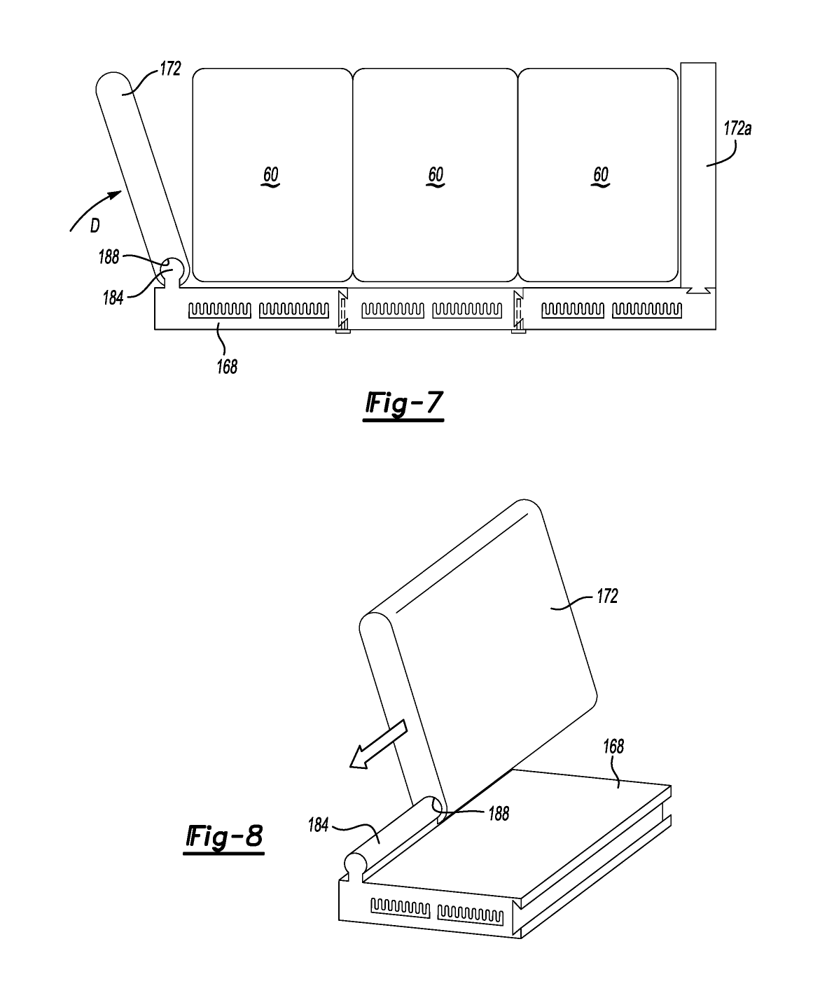

With reference to the exemplary embodiment of FIGS. 7-9, in another exemplary embodiment, a battery pack wall 172 can interlock with a male feature 184 of a battery pack wall 172 by slideably receiving the male feature 184 within a corresponding female feature 188 of the battery pack wall 172. In another example, the male feature 184 and the female feature 188 could be reversed such that the male feature is part of the battery pack wall 172 and the female feature 188 is part of the battery pack wall 172.

The male feature 184 and female feature 188 are configured such that, when the male feature 184 is received within the female feature 188, the battery pack wall 172 can pivot toward the arrays 60 in a direction D about a direction aligned with the axis A.

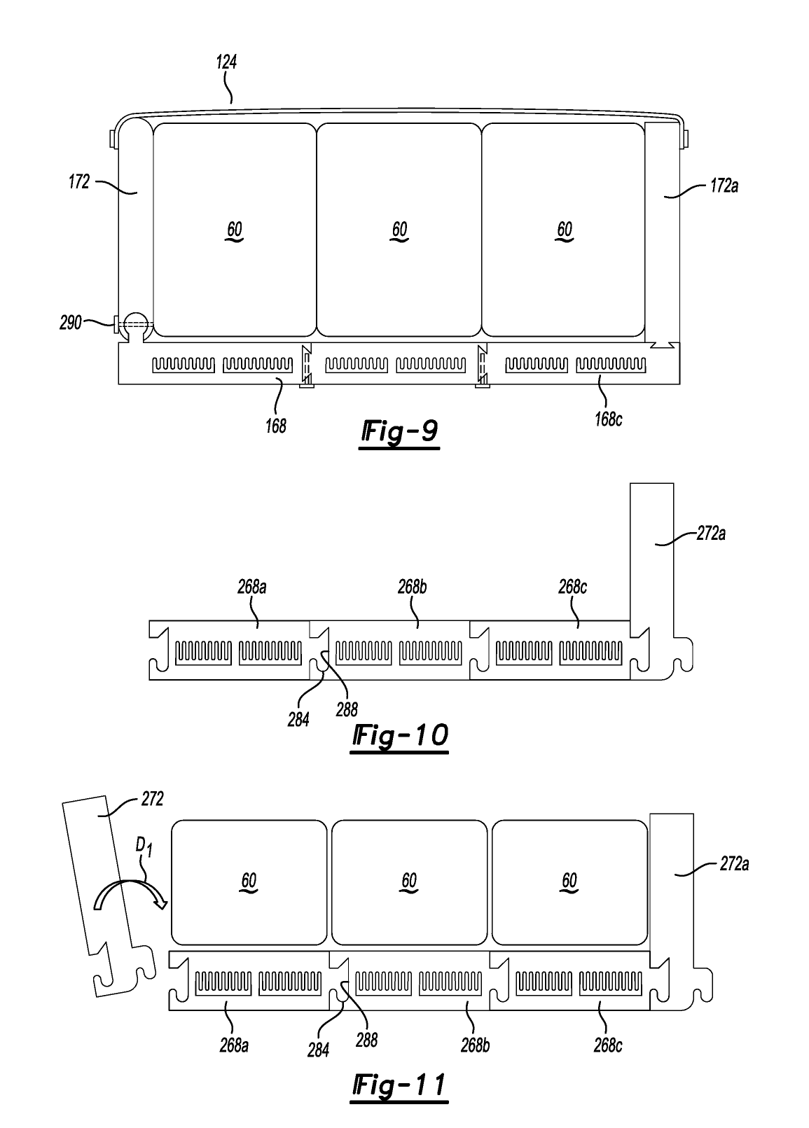

As shown in FIG. 7, the battery pack wall 172 can be positioned such that the battery pack wall 172 is rotated away from an interior of the battery pack to provide clearance for positioning of the arrays 60 within the interior of the battery pack. After the arrays 60 are positioned upon the thermal exchange plate 168 and remaining thermal exchange plates, the battery pack wall 172 can be rotated in the direction D toward the arrays 60. Optionally, a pin 290 can be used to then hold the battery pack wall 172 in the position of FIG. 9.

A tensioning member 124, such as a band or a cover that encloses the arrays 60 between the walls 172, can be secured to the battery pack wall 172 and another battery pack wall 172 (or other structure) to further help hold the battery pack walls 172 against the arrays 60 in the position of FIG. 9. The tensioning member 124 can, in some examples, compress the battery pack walls 172 against the arrays 60 within an interior area of the battery pack. In some examples, a spacer (not shown) can be positioned between one, or both, of the battery pack walls 172 and the array 60 to take up any open area and ensure that rotation of the battery pack wall 172 exerts pressure against the array.

The battery pack wall 172 is, in this example, interlocked with a thermal exchange plate 168 via a male feature received within a female feature. The interlocking structures between the thermal exchange plate 168 and the battery pack wall 172 are on a surface of the thermal exchange plate 168 that interfaces directly with the arrays 60 rather than the lateral side of the thermal exchange plate 168.

Like interlocking of the thermal exchange plates 168, the battery pack walls 172 can be held relative to the respective thermal exchange plate 168 with adhesives, pins, or both.

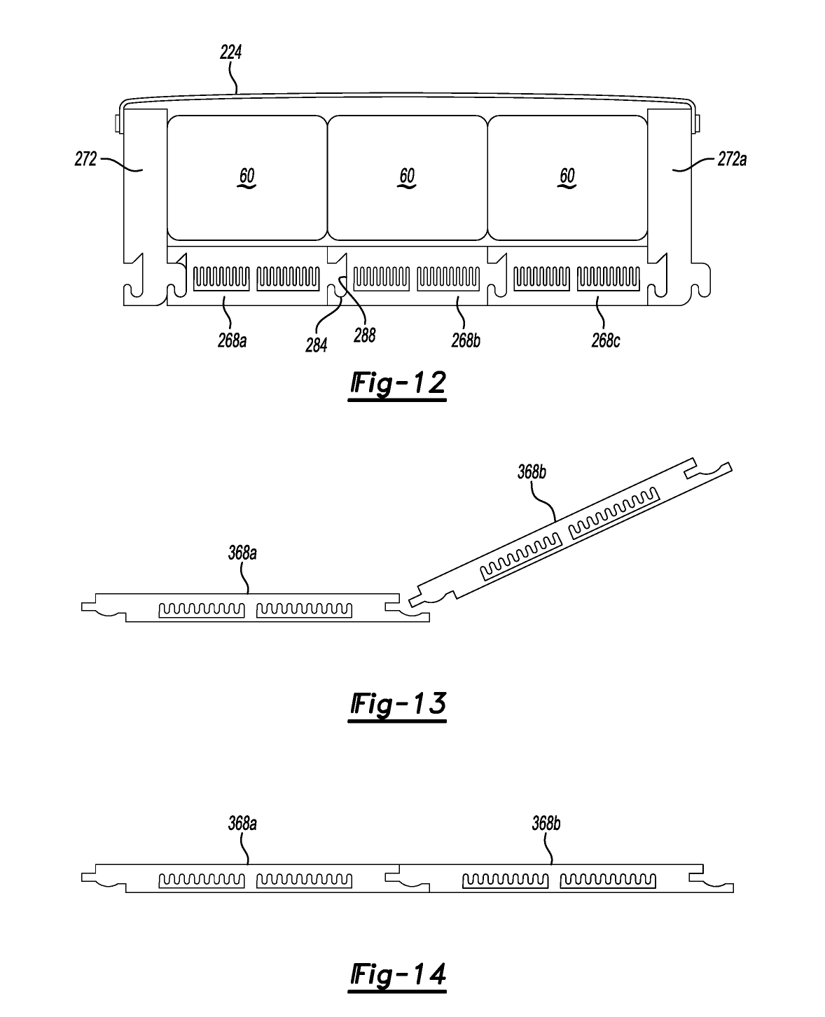

Referring now to FIGS. 10-12, in another exemplary embodiment, thermal exchange plates 268a-268c interlock with each other via male features 284 and female features 288. The male features 284 and female features 288 have a different cross-sectional profile than the dovetail profile in the embodiments of FIGS. 2-9.

Due to the cross-sectional profiles, the battery pack wall 272 can be interlocked with the thermal exchange plate 268a by moving the battery pack wall 272 generally in a direction D₁. This movement positions a male feature of the battery pack wall 272 within the female feature 288 of the thermal exchange plate 268a. Thus, although possible, the battery pack wall 272 is not required to slide along a longitudinal axis of the battery pack wall 272 in order to interlock with the thermal exchange plate 268a.

A tensioning member 224 can then be used to secure to the battery pack wall 272 relative to the battery pack wall 272a. The securing prevents the battery pack wall 272 from tipping in a direction opposite the direction D to a position where the battery pack wall 272 is no longer interlocked with the thermal exchange plate 268a.

Once interlocked, the thermal exchange plates 268a-268c and battery pack walls 272, 272a can be held together with adhesives, pins, or both.

The male features 284 and female features 288 can be held with the assembly of the battery pack by, among other things, allowing the arrays 60 to be positioned on the thermal exchange plates 268a-268c before installing the battery pack wall 272 and applying the tensioning member 224.

Referring now to FIGS. 13 and 14, thermal exchange plates 368a and 368b can interlock with each other via male and female interlock structures, and without requiring a sliding of the thermal exchange plates 368a and 368b relative to each other along a longitudinal axis. Instead, the thermal exchange plate 368a and 368b can be substantially snap-fit relative to each other. Once interlocked, the thermal exchange plates 368a, 368b can be held relative to each other with adhesives, pins, or both.

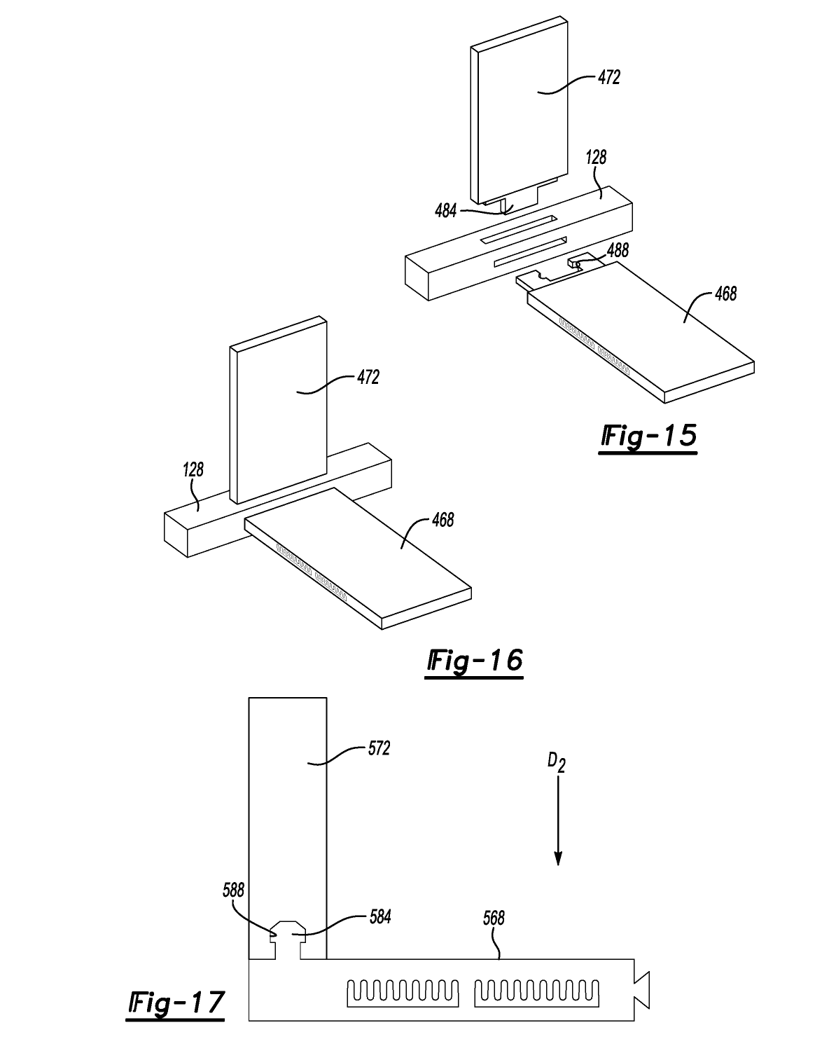

Referring now to FIGS. 15 and 16, yet another exemplary embodiment includes a thermal exchange plate 468 that interlocks with a battery pack wall 472 through a rail structure 128. When a male feature 484 of the battery pack wall 472 is positioned within a female feature 488 of the thermal exchange plate 468, the thermal exchange plate 468 is interlocked relative to the battery pack wall 472.

Although described as having a male feature 484 extending from the battery pack wall 472 and the female feature 488 provided within the thermal exchange plate 468, the connections could be reversed such that the thermal exchange plate 468 includes the male feature 484 and the battery pack wall 472 provides the female feature 488.

Further, although shown as connecting thermal exchange plate 468 to an battery pack wall 472, a similar connection strategy could be utilized to connect the thermal exchange plate 468 to an adjacent thermal exchange plate within a battery pack, particularly, if thermal exchange plates were desired to be positioned along sides of a battery array 60 that are transverse to one another.

One interlocked, the thermal exchange plate 468 and the battery pack wall 472 can be held together with adhesives, pins, or both.

Referring now to FIG. 17, yet another exemplary embodiment includes a thermal exchange plate 568 incorporating a male feature 584, and a battery pack wall 572 incorporating a female feature 588. The thermal exchange plate 568, the battery pack wall 572, or both, can be extruded.

The male feature 584 includes an enlarged head. The battery pack wall 572 can be pushed in a direction D₂ move the female feature 588 over the head of the male feature 584 such that the head is fully received within the female feature 588. When the male feature 584 is received within the female feature 588, the battery pack wall 572 is interlocked to the thermal exchange plate 568.

Although shown with the male feature 584 extending from the thermal exchange plate 568 and the female feature 588 provided within the battery pack wall 572, the arrangement could be reversed such that the male feature 584 extends from the battery pack wall 572 and the female feature 588 is provided within the thermal exchange plate 568. Further, as shown as interconnecting the battery pack wall 572 with thermal exchange plate 568, another example could utilize a similar connection strategy to interlock the thermal exchange plate 568 to an adjacent thermal exchange plate 568.

Once interlocked, the male feature 584 can be held within the female feature 588 with adhesives, pins, or both.

Features of the disclosed examples, include a modular style thermal exchange plate. The modularity of the thermal exchange plate facilitates rapid and efficient changes to a size of the battery pack, as desired. Interlocking features of the thermal exchange plates can reduce an overall weight of the battery pack due to the elimination of bolts and nuts and other traditional mechanical type fasteners. Further, the modular connection strategy, in some examples, does not require relatively complex joining and machining processes. In some exemplary embodiments, the thermal exchange plates and battery pack walls can be extruded which can reduce manufacturing complexity.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

What is claimed is:

1. A battery assembly, comprising:
a first thermal exchange plate having a male feature; and
a second thermal exchange plate having a female feature, the male and female features interlockable with one another to limit separation between the first and second thermal exchange plates.

2. The assembly of claim 1, wherein the male feature is slideably received within the female feature.

3. The assembly of claim 2, further comprising at least one pin that interfaces with the male feature and the female feature to limit the male feature and the female feature from sliding relative to each other.

4. The assembly of claim 1, wherein the male and female features have a dovetail-type cross-sectional profile.

5. The assembly of claim 1, wherein a geometry of the first thermal exchange plate mimics a geometry of the second thermal exchange plate.

6. The assembly of claim 1, wherein the first and second thermal exchange plates are extruded structures.

7. The assembly of claim 1, wherein the male feature and the remaining portions of the first thermal exchange plate are formed together as a single unitary structure.

8. The assembly of claim 1, wherein the first and second thermal exchange plates each include a plurality of coolant channels having first ends opening to respective first sides of the first and second thermal exchange plates and second ends opening to respective second sides of the first and second thermal exchange plates, the first sides opposite the second sides.

9. The assembly of claim 8, further comprising a first manifold adjacent the first sides and a second manifold adjacent the second sides, the first and second manifolds configured to communicate a coolant from some of the plurality of coolant channels to others of the plurality of coolant channels.

10. The assembly of claim 8, wherein the male feature of the first thermal exchange plate extends along a longitudinal axis, and the plurality of coolant channels of the first thermal exchange plate extend from the first side to the second side along respective coolant channel axes that are substantially parallel to the longitudinal axis of the male feature.

11. The assembly of claim 1, further comprising a battery pack wall with a battery pack wall interlock feature that is interlockable with a corresponding battery pack wall interlock feature of the first thermal exchange plate.

12. The assembly of claim 11, wherein the battery pack wall interlock feature of the battery pack wall is slideably engaged with the battery pack wall interlock feature of the first thermal exchange plate.

13. The assembly of claim 11, wherein the battery pack wall interlock features of the battery pack wall and the first thermal exchange plate extend along respective longitudinal axes, and the battery pack wall is pivotable relative to the first thermal exchange plate about the longitudinal axes.

14. The assembly of claim 13, further comprising a plurality of battery cells and a tensioning member, the tensioning member configured to hold the battery pack wall in a pivoted position where the battery pack wall compresses the plurality of battery cells.

15. The assembly of claim 1, further comprising a female feature of the first thermal exchange plate on a side of the thermal exchange plate opposite the male feature, the female feature of the first thermal exchange plate having a cross-sectional profile mimicking a cross-sectional profile of the male feature of the first thermal exchange plate.

16. A method, comprising:
interlocking a male feature of a first thermal exchange plate with a female feature of a second thermal exchange plate to limit separation between the first and second thermal exchange plates.

17. The method of claim 16, further comprising slideably receiving the male feature within the female feature to interlock the first and second thermal exchange plates.

18. The method of claim 16, further comprising, after the interlocking, pinning the male and female features to prevent withdrawal of the male feature from the female feature.

19. The method of claim 16, wherein the male feature extends along a first side of the first thermal exchange plate and further comprising interlocking a third thermal exchange plate or a battery pack wall with a female feature of the first thermal exchange plate, the female feature of the first thermal exchange plate extending along a second side of the first thermal exchange plate that is opposite the second side.

20. The method of claim 19, wherein the male feature extending along the first side of the first thermal exchange plate has a cross-sectional profile that mimics a cross-sectional profile of the female feature extending along the second side of the first thermal exchange plate.
